(19) United States
(12) Patent Application Publication
(10) Pub. No.: US 2010/0200678 A1
(43) Pub. Date: Aug. 12, 2010

(54) FUEL INJECTION VALVE OF ACCUMULATOR INJECTION SYSTEM

(76) Inventor: Hisao Ogawa, Kanagawa (JP)

Correspondence Address: WENDEROTH, LIND & PONACK, L.L.P., 1030 15th Street, N.W.,, Suite 400 East, Washington, DC, 20005-1503, US

(21) Appl. No.: 12/673,376

(22) PCT Filed: Sep. 25, 2008
(86) PCT No.: PCT/JP2008/067867

§ 371 Date: Mar. 18, 2010

(30) Foreign Application Priority Data
Dec. 5, 2007 (JP) 2007-315270

(51) Int. Cl. B05B 1/30

(52) U.S. Cl. 239/584

(57) ABSTRACT

Providing a fuel injection valve of the accumulator injection system, whereby the surge pressure caused by the change of the fuel injection rate when the nozzle needle begin to be seated on or be lifted up from the valve seat is reduced or lessened; the deterioration as to the fuel injection performance and the strength of the injection valve components the deterioration which is caused by the surge pressures is prevented. A fuel injection valve of the accumulator injection system, the fuel injection valve comprising: a nozzle in which at least one nozzle is provided; a nozzle needle which is fitted into the inner cylindrical space of the nozzle so that the nozzle needle 2 slides in the inner cylindrical space with reciprocating movements; thereby, the high pressure fuel accumulated in a highly pressurized fuel accumulator is injected into the combustion chamber through the nozzle hole, in response to the lift of the nozzle needle from the valve seat in the nozzle, wherein a throat which opening is smaller than the opening (lift opening) as to the lift of the nozzle needle while the lift opening is not larger than a certain level is provided at an upstream side of the valve seat, so that the highly pressurized fuel flow is squeezed.

### BACKGROUND OF THE INVENTION

1. Field of the Invention

The present invention relates to a fuel injection valve and a means for eradicating the surge pressure occurrence or propagation in the fuel injection valve of the accumulator injection system (a common-rail injection system), the fuel injection valve injecting the high pressure fuel supplied from a pressurized fuel accumulator, into an engine combustion chamber, through at least one nozzle hole provided in a nozzle of the valve.

2. Background of the Invention

FIG. 3 shows an outline cross-section as to an example of a fuel injection valve of the accumulator injection system (a common-rail injection system). As shown in FIG. 3, the fuel injection valve 100 comprises: a nozzle 1 that is provided with at least one nozzle hole 4 which are placed at the tip part of the nozzle, thereby fuel is injected through the nozzle hole, and

a nozzle needle 2 is fitted into the inner cylindrical space of the nozzle 1 so that the nozzle needle 2 slides in the inner cylindrical space with reciprocating movements; a spacer 6; and, a (fuel injection valve) body 7 to which the nozzle 1 and the spacer 6 are tightly attached by a nozzle holder 17, for example, by the screw mechanism of the nozzle holder.

While the nozzle needle 2 is being pressed on a valve seat 5a of the nozzle 1, the fuel injection valve is kept under a closed condition. The nozzle needle 2 is annexed to a needle spring shoe 8a above the nozzle needle 2 and a push rod 8b that is placed above the a needle spring shoe 8a and fitted into the inner cylindrical space of the fuel injection valve body 7 so that the push rod slides in the inner cylindrical space with reciprocating movements. The numeral 9 denotes a needle spring that presses the nozzle needle 2 against the valve seat 5a, namely, the needle spring determines the opening pressure of the nozzle needle valve.

The numeral 11 denotes a fuel inlet piece in which a fuel inlet passage 12 is formed. The fuel inlet passage 12 communicates with a fuel passage 14a and a fuel passage 14b that are formed in the fuel injection valve body 7, thereby the fuel passage 14a communicates with a fuel sump 5 that is a space filled with fuel in the nozzle and surrounds the nozzle needle 2.

On the other hand, the fuel passage 14b communicates with a backward space of the push rod 8b, namely, a space above the push rod 8b via an orifice 13; thus, with a fuel pressure in the backward space, the push rod 8b, the needle spring shoe 8a and the nozzle needle can be thrust downward toward the valve seat (in the case where the needle valve is closed).

The numeral 14 denotes a solenoid that actuates a pilot needle valve locating at an upper side of the fuel injection valve; when the pilot needle valve is closed, the pressure in the space above the push rod holds so that the nozzle needle 2 is closed; on the other hand, when the pilot needle valve is opened, the pressure in the space above the push rod is released so that the nozzle needle 2 is opened. Thus, the fuel injection timing is controlled. In addition, the numeral 24 denotes a fuel drain passage.

In the fuel injection valve 100 as described above, when the solenoid 14 activates the pilot needle valve, a passage 10 is opened; at the same time, the fuel from the fuel inlet passage 12 is supplied toward the fuel sump 5 through the fuel passage 14a; then, the fuel pressure force acts on the nozzle needle 2 from the lower side thereof; thus, the nozzle needle comes apart from the valve seat 5a, and the fuel is injected into the combustion chamber through the nozzle hole 4.

Further, the patent reference 1 (JP2000-27734) discloses an example as to the fuel injection valve of the accumulator injection system, whereby the steep rising of the fuel injection rate is restrained so as to reduce the nitrogen oxide generation (NOx generation).

FIGS. 4, 4(A), 4(B) and 4(C) explain the state of the fuel injection as to the fuel injection valve 100 of the accumulator injection system (i.e. a common-rail injection system) as depicted in FIG. 3.

In FIG. 4, when the fuel injection valve 100 of the accumulator injection system (i.e. the common-rail injection system) is about to stop an injection shot, a high pressure injection rate (see FIG. 4(C)) is maintained until the moment before the injection shot is completed in order to inject the highly pressurized fuel that is accumulated in the common-rail; under such a condition, the nozzle needle 2 is going to sit on the valve seat 5a so that the fuel injection valve closes. In this connection, FIG. 4(A) depicts the change as to the lift of the nozzle needle 2.

As explained above, the change of the fuel injection rate during the nozzle needle closing is so great that a high surge pressure S is caused in the high-pressure fuel lines (such as a high-pressure line 19, the fuel passage 14a and the fuel passage 14b) as depicted in FIG. 4(B).

The larger the capacity of the fuel injection valve that is installed in an engine, the more remarkable the surge pressure S. When the level of the surge pressure S exceeds an allowable limit, the fuel injection performance is spoiled and the strength of the components of the injection valve is impaired.

Further, the great change of the fuel injection rate at the injection commencement is a potential factor to deteriorate exhaust gas emission properties.

In the disclosure of the patent reference 1, the fuel injection valve is provided with a major nozzle needle (a master nozzle needle) and a subsidiary nozzle needle (a slave nozzle needle) that are operated independently of each other; thereby, at the commencement of the injection shot, the fuel injection rate is controlled so that the injection rate is restrained only by use of the lift of the major nozzle needle; after the fuel injection rate reaches a certain amount (a prescribed or predetermined amount), both the nozzle needles are operated together; thus, the change of the fuel injection rate in the beginning of a fuel injection shot is slow in raising, and the nitrogen oxide generation (NOx generation) is restrained.

Further to the above explanation regarding the disclosure of the reference 1, the movement limitation mechanism such as a stopper is provided for both the nozzle needles that are operated independently of each other; thus, the configuration of the fuel injection valve becomes complicated; further, since such a pair of the intricate nozzle needles is incorporated near the tip part of the nozzle the tip part which is exposed to high temperature, both the nozzle needles are prone to be operated under an unstable repeatability condition or under a mutually uncoupled movement condition.

### SUMMARY OF THE INVENTION

In view of the above-stated conventional technologies and anticipated solutions thereof, the present disclosure aims at providing a fuel injection valve of the accumulator injection system, whereby the surge pressure caused by the change of the fuel injection rate when the nozzle needle begins to be seated on or be lifted up from the valve seat is reduced or lessened; the deterioration as to the fuel injection performance and the strength of the injection valve components the deterioration which is caused by the surge pressures is prevented.

In order to achieve the above objective, the present invention discloses a fuel injection valve of the accumulator injection system, the fuel injection valve comprising:
a nozzle in which at least one nozzle is provided;
a nozzle needle which is fitted into the inner cylindrical space of the nozzle so that the nozzle needle slides in the inner cylindrical space with reciprocating movements;
thereby, the high pressure fuel accumulated in a highly pressurized fuel accumulator is injected into the combustion chamber through the nozzle hole, in response to the lift of the nozzle needle from the (needle) valve seat in the nozzle,
wherein
a throat which opening is smaller than the opening (the lift opening) as to the lift of the nozzle needle while the lift opening is not larger than a certain (prescribed or predetermined) level is provided at an upstream side of the valve seat, so that the highly pressurized fuel flow is squeezed.

The preferable configurations according to the present invention are as follows:

(1) the throat apart from the lift opening is provided at each upper edge of more than two vertical grooves that are engraved on the outer periphery surface of the nozzle needle and form more than two passages of the highly pressurized fuel, the throat being provided on the upstream side of the lift opening;

(2) the throat apart from the lift opening is provided between
an outer conical surface around the needle the outer conical surface which is formed at an upstream side of the valve seat for the needle, and
an inner conical surface in the nozzle the inner conical surface which corresponds to the outer conical surface,
   so that the opening as to the provided throat is smaller than the lift opening while the lift opening is not larger than a certain (prescribed or predetermined) level.

According to the present invention, the fuel injection valve is provided
a throat which opening is smaller than the opening (lift opening) as to the lift of the nozzle needle while the lift opening is not larger than a certain level is provided at an upstream side of the valve seat, so that the highly pressurized fuel flow is squeezed;
the injection valve as an embodiment of the invention is provided with the throat apart from the lift opening the throat which is provided at each upper edge of more than two vertical grooves that are engraved on the outer periphery surface of the nozzle needle and form more than two passages of the highly pressurized fuel, the throat being provided on the upstream side of the lift opening; or
the injection valve as an embodiment of the invention is provided with the throat apart from the lift opening the throat which is provided between
an outer conical surface around the needle the outer conical surface which is formed at an upstream side of the valve seat for the needle, and
an inner conical surface in the nozzle the inner conical surface which corresponds to the outer conical surface,
so that the opening as to the provided throat is smaller than the lift opening while the lift opening is not larger than a certain level;
thus, the throat apart from the lift opening squeezes the highly pressurized fuel flow toward the valve seat while the lift opening is not larger than a the certain level; accordingly, the slope as to the fuel injection rate (to which the fuel flow downward through the opening toward the valve seat 5a corresponds) becomes gentler thanks to the throttle effect;
on the other hand, when the lift opening, namely, the opening between the nozzle needle 2 and the valve seat 5a exceeds the certain level, the throat no longer forms a throttle; then, the injection flow rate is determined only by the lift opening; namely, the injection flow rate is not influenced by the upper throat that no longer forms a throttle; thus, the highly pressurized fuel is injected without the influence of the throttle.

Therefore, since the slope as to the fuel injection rate becomes gentler during the period where the lift opening between the nozzle needle 2 and the valve seat 5a is smaller than the certain level, the surge pressures can be restrained; as a result, a fuel injection device is obtained whereby the deterioration as to the fuel injection performance and the strength of the injection valve components the deterioration which is caused by the surge pressure can be prevented. Further, since the slope as to the fuel injection rate becomes gentler during the period where the lift opening between the nozzle needle and the valve seat reaches the certain level, from the commencement of the needle valve opening, the nitrogen oxide generation (NOx generation) can be reduced, and the exhaust gas emission properties can be improved.

According to the first embodiment, the throat apart from the lift opening is provided at each upper edge of more than two vertical grooves that are engraved on the outer periphery surface of the nozzle needle and form more than two passages of the highly pressurized fuel, the throat being provided at the each upper edge of the grooves, on the upstream side of the lift opening; on the other hand, according to the second embodiment, the throat apart from the lift opening is provided between
an outer conical surface around the needle the outer conical surface which is formed at an upstream side of the valve seat for the nozzle needle, and
an inner conical surface in the nozzle the inner conical surface which corresponds to the outer conical surface,
so that the opening as to the provided throat is smaller than the lift opening while the lift opening is not larger than a certain level.

Thus, the configuration of the first embodiment can be realized by the structure only of the nozzle needle, while the configuration of the second embodiment can be realized by the combination of the structures of the nozzle needle and the nozzle. Accordingly, in comparison with the structure disclosed by the patent reference 1, the present invention provides a fuel injection valve of a simple structure; further, the structure near the tip part of the nozzle can be simple the tip part which is exposed to high temperature. Thus, the fuel injection can be operated under a stable repeatability condition.

### BRIEF DESCRIPTION OF THE DRAWINGS

FIGS. 1(A) to 1(F) show a fuel injection valve of the accumulator injection system, according to the first embodiment of the present invention;

FIG. 1(A) shows a cross section of the fuel injection valve so as to depict the major components thereof;

FIG. 1(B) shows the detail of the part “A” in FIG. 1(A);

FIG. 1(C) shows the “A-A” cross section denoted by FIG. 1(B);

FIG. 1(D) shows the lift transition curve of the L0 nozzle needle;

FIG. 1(E) shows the pressure transition curve as to the fuel (line) pressure;

FIG. 1(F) shows the transition curve as to the fuel injection rate;

FIGS. 2(A) to 2(F) show an outline configuration of the fuel injection valve of the accumulator injection system, according to the second embodiment of the present invention.

FIG. 2(A) shows a cross section of the fuel injection valve so as to depict the major components thereof.

FIG. 2(B) shows the detail of the part “A” in FIG. 2(A);

FIG. 2(D) shows the lift transition curve of the nozzle needle;

FIG. 2(E) shows the pressure transition curve as to the fuel (line) pressure;

FIG. 2(F) shows the transition curve as to the fuel injection rate.

FIG. 3 shows an outline cross-section as to an example of a fuel injection valve of the accumulator injection system (a common-rail injection system);

FIGS. 4, 4(A), 4(B) and 4(C) explain the injection conditions as to the fuel injection valve of the accumulator injection system (i.e. a common-rail injection system) as depicted in FIG. 3.

### DETAILED DESCRIPTION OF THE PREFERRED EMBODIMENTS

Hereafter, the present invention will be described in detail with reference to the embodiments shown in the figures. However, the dimensions, materials, shape, the relative placement and so on of a component described in these embodiments shall not be construed as limiting the scope of the invention thereto, unless especially specific mention is made.

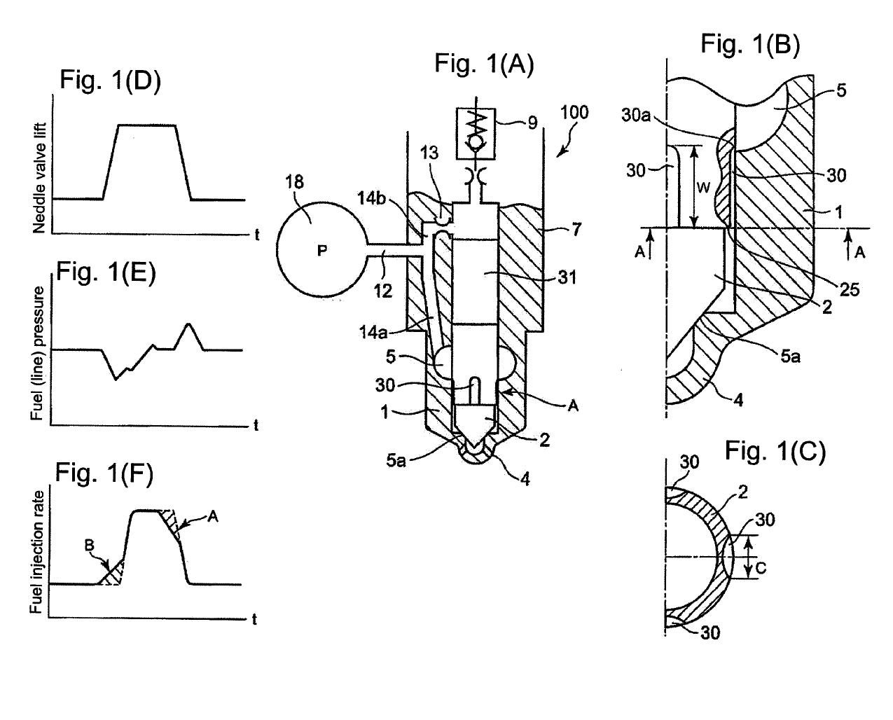

FIGS. 1(A) to 1(F) depicts an outline configuration as to a fuel injection valve of the accumulator injection system, according to the first embodiment of the present invention.

In FIGS. 1(A) to 1(C), an fuel injection valve 100 is provided with:
a nozzle 1 that is provided with at least one nozzle hole 4 which are placed at the tip part of the nozzle, thereby fuel is injected through the nozzle hole;
a nozzle needle 2 that is fitted into the inner cylindrical space of the nozzle 1 so that the nozzle needle 2 slides in the inner cylindrical space with reciprocating movements; and,
a (fuel injection valve) body 7.

While the nozzle needle 2 is being pressed on a valve seat 5a of the nozzle 1, the fuel injection valve or the needle valve 2 is held under closed conditions.

The numeral 18 denotes a pressurized fuel accumulator to which a fuel inlet passage 12 is communicated. The fuel inlet passage 12 communicates with a fuel passage 14a and a fuel passage 14b. Further, the fuel passage 14a communicates with a fuel sump 5 that is a space filled with fuel in the nozzle and surrounds the nozzle needle 2.

On the other hand, the fuel passage 14b communicates with a backward space of the push rod 8b, namely, a space above a control rod 31 via the orifice 13; thus, with a fuel pressure, the control rod 31, the needle spring shoe 8a and the nozzle needle can be thrust downward toward the valve seat. In addition, the fuel injection valve is provided with a solenoid for operating the fuel injection valve, namely, the nozzle needle 2; the nozzle needle valve 2 is operated so as to close or open, through the movements of the pilot needle valve that is operated by the solenoid.

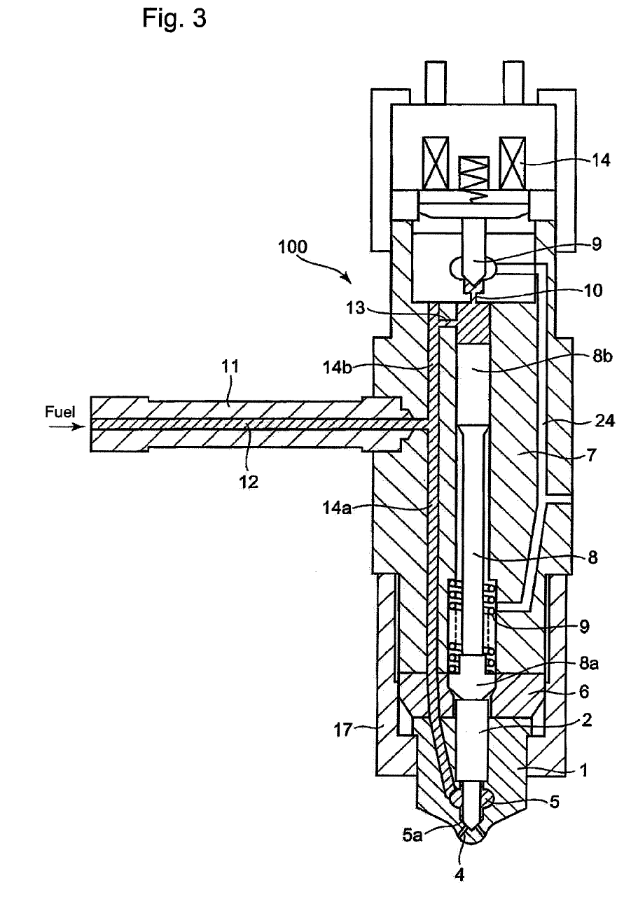

The other configuration that is not described in the above explanation in relation to FIGS. 1(A) to 1(C) is the same as the configuration described in relation to FIG. 3.

### First Embodiment

In the first embodiment as shown in FIGS. 1(A) to 1(C), the nozzle needle 2 is provided with a step 25 at the lower guide part of the nozzle needle 2; upward the step 25, more than two vertical grooves 30 of the width C and the length W are formed on the surface of the lower guide part of the nozzle needle 2 along the flow direction of the highly pressurized fuel downward the nozzle needle. As shown in FIG. 1(B), a flow throat at the upper edge 30a of each groove 30 is formed only while the needle valve 2 begins to open till the nozzle needle is lifted up so that the throat is no longer a throttle that squeezes the fuel flow downward the groove to the valve seat 5a, namely, until the opening between the nozzle needle 2 and the valve seat 5a reaches the certain level. Thus, the highly pressurized fuel flow downward through the opening is restrained during the period where the lift of the nozzle needle is smaller than a certain level.

Accordingly, during the period where the opening between the nozzle needle 2 and the valve seat 5a reaches the certain level, the slope as to the fuel injection rate (to which the fuel flow downward through the opening toward the valve seat 5a corresponds) becomes gentler thanks to the throttle effect, in comparison with a case where the grooves 30 and the throats thereof are dispensed with, as the pointers A and B in FIG. 1(F) indicates.

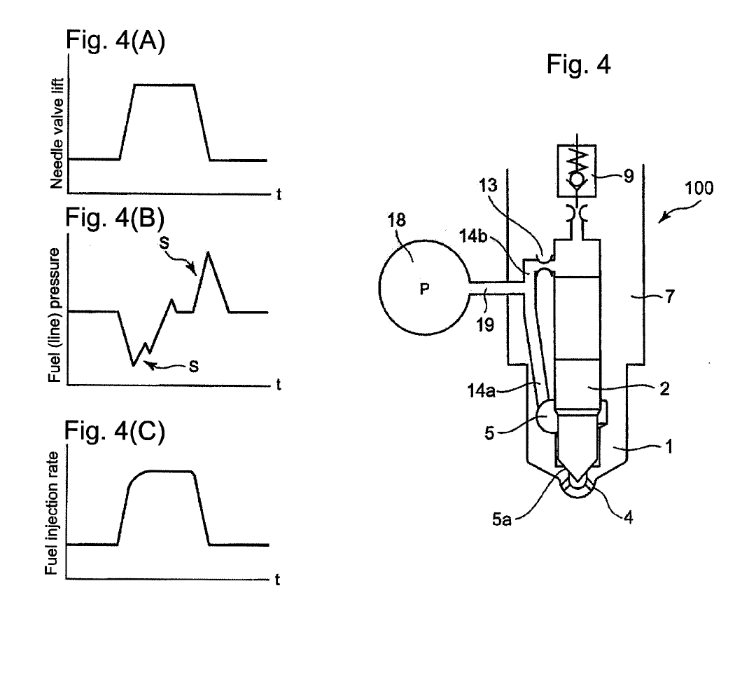

Thus, thanks to the grooves 30 and the throats thereof, the slope as to the fuel injection rate becomes gentler during the period where the opening between the nozzle needle 2 and the valve seat 5a is smaller than the certain level; therefore, as shown in FIG. 1(E), the surge pressures are restrained (compare FIG. 1(E) and FIG. 4(B)); as a result, a fuel injection device is obtained whereby the deterioration as to the fuel injection performance and the strength of the injection valve components the deterioration which is caused by the surge pressure can be prevented. Further, since the slope as to the fuel injection rate becomes gentler during the period where the opening between the nozzle needle 2 and the valve seat 5a reaches the certain level, from the commencement of the needle valve opening, the nitrogen oxide generation (NOx generation) can be reduced, and the exhaust gas emission properties can be improved.

In addition, when the opening between the nozzle needle 2 and the valve seat 5a (i.e. the lift of the nozzle needle) exceeds the certain level, the upper edge of the groove no longer forms a throttle; then, the injection flow rate is determined only by the opening (the lift opening) over the seat 5a (i.e. the lift of the nozzle needle); namely, the injection flow rate is not influenced by the upper throat that no longer forms a throttle; thus, the highly pressurized fuel is injected without the influence of the throttle.

### Second Embodiment

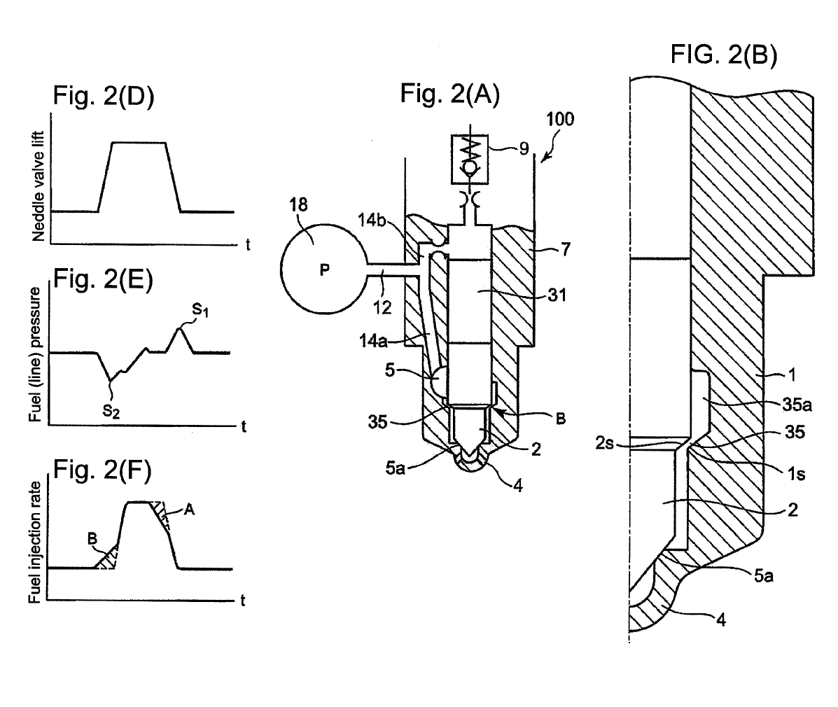

In the second embodiment as shown in FIGS. 2(A) and 2(B), a throat 35 is provided between the nozzle needle 2 and the nozzle 1.

In other words, the throat 35 is formed between:
an inner conical surface 2s provided at a lower part of an undercut part 35a that is provided by undercutting the fuel sump 5 in the nozzle, the inner conical surface being located at the upstream side of the valve seat 5a for the nozzle needle 2; and,
an outer conical surface 1s provided around the needle, the outer conical surface is being located in response to the inner conical surface 2s,
so that the opening of the throat 35 is configured so as to be smaller than the lift opening while the lift opening is not larger than a certain level.

Accordingly, as shown in FIG. 2(B), the opening of the throat 35 is slightly opened when the nozzle needle 2 sits on the valve seat 5a; and, the slightly opened condition as to the throat 35 continues for a (prescribed or predetermined) period while the lift opening is not larger than a certain level; thus, the highly pressurized fuel toward the valve seat 5a is squeezed.

Consequently, as the pointers A and B in FIG. 2(F) indicates, the slope as to the fuel injection rate (to which the fuel flow downward through the opening toward the valve seat 5a corresponds) becomes gentler thanks to the throttle effect by the throat 35, while the lift opening is not larger than the certain level.

Therefore, since the slope as to the fuel injection rate becomes gentler during the period where the lift opening between the nozzle needle 2 and the valve seat 5a is smaller than the certain level, the surge pressures can be restrained, as shown in FIG. 2(E), as a result, a fuel injection device is obtained whereby the deterioration as to the fuel injection performance and the strength of the injection valve components the deterioration which is caused by the surge pressure can be prevented. Further, since the slope as to the fuel injection rate becomes gentler during the period where the lift opening between the nozzle needle 2 and the valve seat 5a reaches the certain level, from the commencement of the needle valve opening, the nitrogen oxide generation (NOx generation) can be reduced, and the exhaust gas emission properties can be improved.

In addition, when the lift opening between the nozzle needle 2 and the valve seat 5a (i.e. the lift of the nozzle needle) exceeds the certain level, the throat 35 no longer forms a throttle; then, the injection flow rate is determined only by the opening over the seat 5a (i.e. the lift or lift opening of the nozzle needle); namely, the injection flow rate is not influenced by the throat 35 that no longer forms a throttle; thus, the highly pressurized fuel is injected without the influence of the throat 35.

As explained thus far, according to the first embodiment, the throat apart from the lift opening is provided at each upper edge of more than two vertical grooves 30 that are engraved on the outer periphery surface of the nozzle needle and form more than two passages of the highly pressurized fuel, the throat being provided at the each upper edge 30a of the grooves, on the upstream side of the lift opening; on the other hand, according to the second embodiment, the throat 35 apart from the lift opening is provided between
an outer conical surface 2s around the needle the outer conical surface which is formed at an upstream side of the valve seat 5a for the nozzle needle 2, and
an inner conical surface 1s in the nozzle the inner conical surface which corresponds to the outer conical surface,
   so that the opening as to the provided throat is smaller than the lift opening while the lift opening is not larger than a certain level.

Thus, the configuration of the first embodiment can be realized by the structure only of the nozzle needle 2, while the configuration of the second embodiment can be realized by the combination of the structures of the nozzle needle 2 and the nozzle 1. Accordingly, in comparison with the structure disclosed by the patent reference 1, the present invention provides a fuel injection valve of a simple structure; further, the structure near the tip part of the nozzle can be simple the tip part which is exposed to high temperature. Thus, the fuel injection can be operated under a stable repeatability condition.

### INDUSTRIAL APPLICABILITY

The present provides a fuel injection valve of the accumulator injection system, whereby the surge pressure caused by the change of the fuel injection rate when the nozzle needle begin to be seated on or be lifted up from the valve seat is reduced or lessened; the deterioration as to the fuel injection performance and the strength of the injection valve components the deterioration which is caused by the surge pressures is prevented.

1. A fuel injection valve of the accumulator injection system, the fuel injection valve comprising:
a nozzle in which at least one nozzle is provided;
a nozzle needle which is fitted into the inner cylindrical space of the nozzle so that the nozzle needle 2 slides in the inner cylindrical space with reciprocating movements;
thereby, the high pressure fuel accumulated in a highly pressurized fuel accumulator is injected into the combustion chamber through the nozzle hole, in response to the lift of the nozzle needle from the valve seat in the nozzle,
wherein
a throat which opening is smaller than the lift opening as to the lift of the nozzle needle while the lift opening is not larger than a certain level is provided at an upstream side of the valve seat, so that the highly pressurized fuel flow is squeezed.

2. The fuel injection valve of the accumulator injection system according to claim 1, whereby
the throat apart from the lift opening is provided at each upper edge of more than two vertical grooves that are engraved on the outer periphery surface of the nozzle needle and form more than two passages of the highly pressurized fuel, the throat being provided on the upstream side of the lift opening.

3. The fuel injection valve of the accumulator injection system according to claim 1, whereby
the throat apart from the lift opening is provided between
an outer conical surface around the needle the outer conical surface which is formed at an upstream side of the valve seat for the needle, and
an inner conical surface in the nozzle the inner conical surface which corresponds to the outer conical surface,
so that the opening as to the provided throat is smaller than the lift opening while the lift opening is not larger than a certain level.
